(19) United States
(12) Patent Application Publication
(10) Pub. No.: US 2024/0207801 A1
(43) Pub. Date: Jun. 27, 2024

(54) ELECTRIFICATION OF HEAT SUPPLY TO FLUIDIZED REGENERATION SYSTEM

(71) Applicant: KELLOGG BROWN & ROOT LLC, Houston, TX (US)

(72) Inventors: Rian Reyneke, Katy, TX (US); Matthew James Griffiths, Arlington Heights, IL (US); Changwook Jeong, Katy, TX (US); Manoj Nagvekar, Sugar Land, TX (US); Kyung Taek Han, Houston, TX (US); Michael J. Tallman, Houston, TX (US)

(73) Assignee: KELLOGG BROWN & ROOT LLC, Houston, TX (US)

(21) Appl. No.: 18/086,786

(22) Filed: Dec. 22, 2022

(51) Int. Cl. B01J 8/26; B01J 8/18; B01J 38/02

(52) U.S. Cl. CPC B01J 8/26; B01J 8/1818; B01J 8/1836; B01J 38/02; B01J 2208/00398; B01J 2208/00407; B01J 2208/00415

(57) ABSTRACT

A system for reactivating a catalyst having a predetermined heat content includes a reactor, a regenerator, and an electrically energized heater. The reactor is configured to generate a spent catalyst. The regenerator is configured to receive the spent catalyst from the reactor. The electrically energized heater has a plurality of energy emitting members at least partially immersed in the spent catalyst. The heater is configured to provide a supplemental heat content to obtain the predetermined heat content.

### TECHNICAL FIELD

The present disclosure relates to catalyst regenerators having reduced carbon emissions.

### BACKGROUND

Regenerated and heated catalyst is used in numerous chemical processing systems. Conventional techniques for regenerating catalyst, or ‘reactivating’ catalyst, use fossil fuels to create the heat necessary to reactivate catalysts.

The present disclosure addresses the need for regenerators that reduce use of fossil fuels to reactivate catalysts, as well as other needs of the prior art.

### SUMMARY

In aspects, the present disclosure provides a system for regenerating a spent catalyst into a reactivated catalyst having a predetermined heat content. The system may include a reactor configured to generate the spent catalyst; a regenerator configured to regenerate the spent catalyst from the reactor; and an electrically energized heater configured to selectively increase a heat content of the spent catalyst to the predetermined heat content, the heater having a plurality of energy emitting members at least partially immersed in the spent catalyst.

In aspects, the present disclosure provides a method for regenerating a spent catalyst into a reactivated catalyst having a predetermined heat content. The method may include the steps of generating a spent catalyst in a reactor; receiving the spent catalyst in a regenerator; at least partially immersing a plurality of energy emitting member of a heater in the spent catalyst; and selectively operating the heater to increase a heat content of the spent catalyst to the predetermined heat content.

It should be understood that certain features of the disclosure have been summarized rather broadly in order that the detailed description thereof that follows may be better understood, and in order that the contributions to the art may be appreciated. There are, of course, additional features of the disclosure that will be described hereinafter and which will in some cases form the subject of the claims appended thereto.

### BRIEF DESCRIPTION OF THE DRAWINGS

For detailed understanding of the present disclosure, references should be made to the following detailed description taken in conjunction with the accompanying drawings, in which like elements have been given like numerals and wherein:

FIG. 1 schematically illustrates a non-limiting embodiment of a regenerator in accordance with one embodiment of the present disclosure that uses an external heater; and

FIG. 2 schematically illustrates a non-limiting embodiment of a regenerator in accordance with one embodiment of the present disclosure that uses an internal heater;

FIG. 3 schematically illustrates another non-limiting embodiment of a regenerator in accordance with one embodiment of the present disclosure that uses an external heater; and

FIGS. 4A and 4B schematically illustrate the energy emitting members of a heater in accordance with one embodiment of the present disclosure.

### DETAILED DESCRIPTION

In aspects, the present disclosure provides systems and related methods for reactivating a catalyst that is circulated in a processing system. In certain embodiments, the present disclosure provides regenerators having reduced carbon emissions as compared to regenerators that use only fossil fuels to generate heat. There are shown in the drawings, and herein will be described in detail, specific embodiments of the present disclosure with the understanding that the present disclosure is to be considered an exemplification of the principles of the disclosure and is not intended to limit the disclosure to that illustrated and described herein.

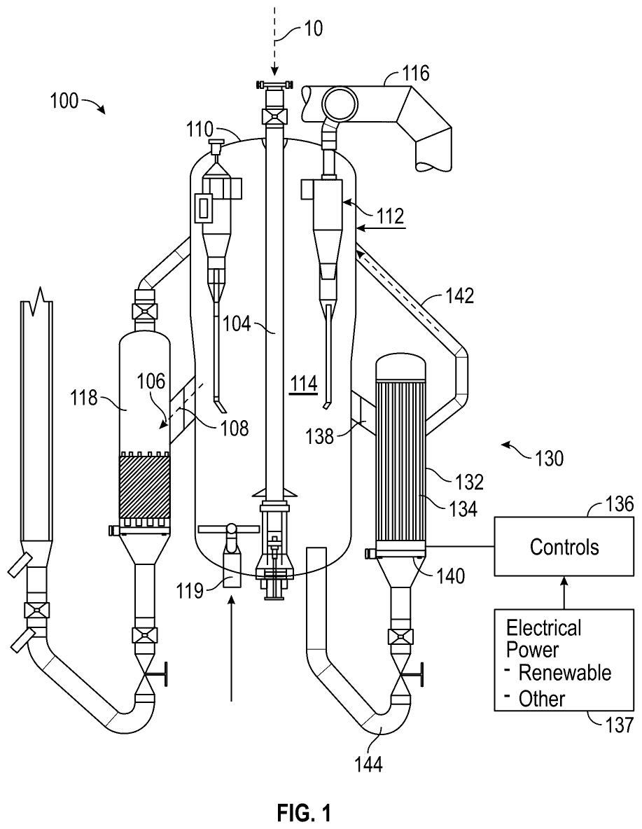

Referring initially to FIG. 1, there is schematically shown a non-limiting embodiment of a regenerator 100 in accordance with the present disclosure that may be incorporated into a processing system. The regenerator 100 may receive a spent catalyst 10 from a reactor (not shown) via a standpipe 104 and output a reactivated catalyst 106 via an outlet 108. By ‘reactivated,’ it is meant that the catalyst has been heated to a predetermined value, or ‘predetermined heat content,’ for use in a reactor (not shown). The predetermined heat content may be based on the heat required in the reactor (not shown) in order for one or more desired chemical reaction to occur. The predetermined heat content may be defined by a ‘value’ that is a singular value, a range of values, and upper limit, or a lower limit. ‘Reactivated’ also means that coke, if present, has been burned off the catalyst particles. The energy required to reactivate the spent catalyst will be referred to as the reactivation energy.

The regenerator 100 includes a vessel 110 that houses a separation system 112 in an interior 114. The separation system 112 may be a cyclonic separation device configured to separate gases from solids. Gases inside the interior 114 may exit via a flue gas plenum 116. In some embodiments, the outlet 108 may be in fluid communication with a catalyst stripper 118, which circulates the reactivated catalyst to the reactor (not shown). Air may be blown into the interior 114 via an inlet 119 to maintain catalyst fluidization and circulation and potentially to burn coke, if present, off of the catalyst particles. As used throughout, the term “spent catalyst” refers to catalyst at any stage of the reactivation process. In some embodiments, the reactivation process is not complete until the catalyst enters a reactor. In other embodiments, the reactivation process is complete after the catalyst exits via the outlet 108.

In accordance with the present teachings, the regenerator 100 can use, if needed, electrical energy to selectively increase the heat content to a catalyst body formed by the spent catalyst. The regenerator 100 may operate in several operating modes. In one mode, the regenerator 100 uses only electrical energy to increase the heat content of the catalyst body to the predetermined heat content. In another mode, the regenerator 100 increases the heat content to the predetermined heat content by using electrical energy in combination with one or more non-electrical energy sources such as the combustion of coke deposits on the catalyst and/or a supplemental fuel source. In still another mode, the regenerator 100 may use only one or more non-electrical energy sources. For example, in some situations, the combustion of coke deposits may supply all of the heat content required to obtain the predetermined heat content. Thus, “selectively increase” means that the regenerator may have several operating modes that can be selected as needed to obtain the predetermined heat content. In one non-limiting embodiment, personnel can monitor operating parameters such as temperature, flow rates, and/or pressure and manually actuate a switch or other device to select the addition of heat content by the regenerator 100. In another non-limiting embodiment, a suitably programmed processor may receive signals from sensors, e.g., temperature gauges, and autonomously select or de-select the adding of heat by the regenerator 100.

In some embodiments, the electrical energy may be generated using a renewable energy source (e.g., wind, solar, hydroelectric, tidal, geothermal, etc.). In other embodiments, the electrical energy may be generate using a low carbon/no carbon energy source (e.g., hydrogen, nuclear, etc.). In still other embodiments, the electrical energy may be generated using hydrocarbon-based fuels.

In one arrangement, one or more electrically energized heaters 130 may be positioned external to the vessel 110. The heater 130 may utilize a ‘shell-and-tube’ type of configuration. As shown, the heater 130 may include a shell 132 in which are disposed an array of energy emitting members 134. The energy emitting members 134 may be energized using a suitable control system 136 and power source 137. The power source 137 may be a renewable power source or conventional power source as previously described. Catalyst from the vessel 110 enters the shell 132 via a suitable inlet 138 and flows downward along the energy emitting members 134. At or near the bottom of the shell 132, a fluidizing agent, such as steam or air, is injected into the shell 132 via a header or other inlet 140. The fluidizing agent flows upward to a gas outlet 142 as the catalyst flows downward to the outlet 144. In embodiments, catalyst density may range between 35 to 40 lb/ft3 and vapor superficial velocity may range between 0.2-0.4 ft/s. In other embodiments, catalyst density may range between 25 to 50 lb/ft3 and vapor superficial velocity may range between 0.1-0.8 ft/s. In still other embodiments, catalyst density may range between 15 to 60 lb/ft3 and vapor superficial velocity may range between 0.01-1.5 ft/s. While one shell 132 is shown, it should be understood that multiple shells may also be used.

In some embodiments, the energy emitting members 134 may be electrical heating members or include electrical heating members. That is, the energy emitting members 124 may directly or indirectly heat the catalyst. It should be noted that during operation, the energy emitting members 134 are immersed in a body of catalyst. By immersed, it is meant at least partially surrounded by catalyst. Thus, the energy emitting members 134 can emit energy, here thermal energy, in multiple directions and multiple locations within the catalyst body. In other embodiments, the energy emitting members 134 may utilize other energy transmission media, such as infrared or induction.

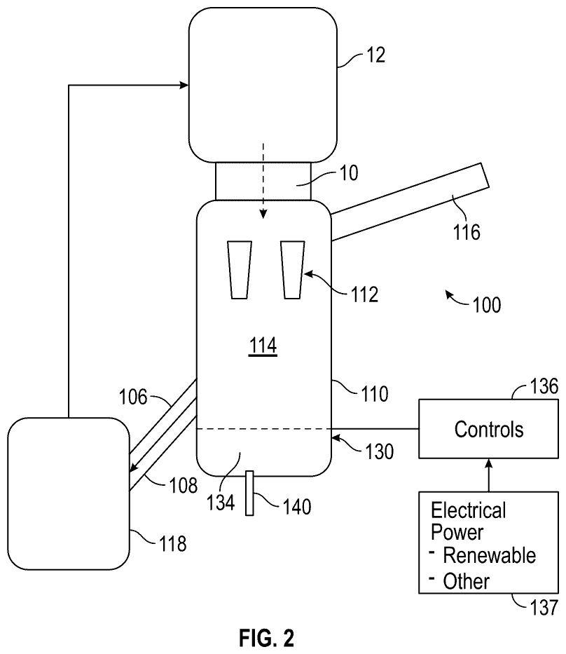

Referring to FIG. 2, there is schematically shown another non-limiting regenerator 100 in accordance with the present disclosure. The regenerator 100 may receive a spent catalyst 10 from a reactor 12 and output a reactivated catalyst 106 via an outlet 108. As in the previously discussed embodiment, the regenerator 100 includes a vessel 110 that houses a separation system 112 in an interior 114. The separation system 112 may be a cyclonic separation device configured to separate gases from solids. Gases inside the interior 114 may exit via a flue gas plenum 116. The outlet 108 may be in fluid communication with a catalyst stripper 118, which circulates the reactivated catalyst to the reactor 12. As noted previously, the term “spent catalyst” refers to catalyst at any stage of the reactivation process.

The regenerator 100 may be configured to use electrical energy to reactivate the spent catalyst. In this embodiment, an electrically energized heater 130 may be positioned internal to the vessel 110. The heater 130 may use an array of energy emitting members 134 as described previously. The energy emitting members 134 may be energized using a suitable control system 136/power source 137, as described previously. At or near the bottom of the vessel 110, a fluidizing agent, such as steam or air, is injected via a header or other inlet 140. As in the FIG. 1 embodiment, the energy emitting members 134 are immersed in a body of catalyst, which may be a bubbling bed/fast fluidizing bed.

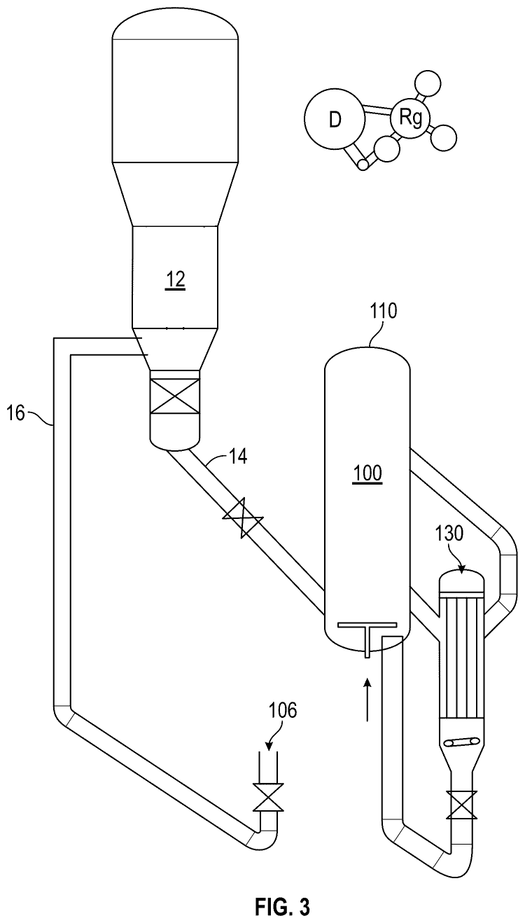

Referring to FIG. 3, there is schematically shown another non-limiting regenerator 100 in accordance with the present disclosure. The regenerator 100 may receive a spent catalyst 10 from a reactor 12 via a line 14 and output a reactivated catalyst 106 to a catalyst stripper (not shown) if present. For the purposes of the present disclosure, a reactor 12 is any structure that forms a spent catalyst by reacting the catalyst with one or more feedstock. The reactivated catalyst 106 is returned to the reactor 12 via a line 16. The regenerator 100 may be configured as described previously. Specifically, an electrically energized heater 130 may be positioned external to a vessel 110 of the regenerator 100 and be configured as described in connection with the FIG. 1 embodiment.

In still other variants not shown, the regenerator may utilize a back-mix flow electrically energized external heater arrangement. In such arrangements, the regenerator does not have a separate inlet and exit for the catalyst. Instead, the catalyst exits from the same passage from which the catalyst entered the regenerator.

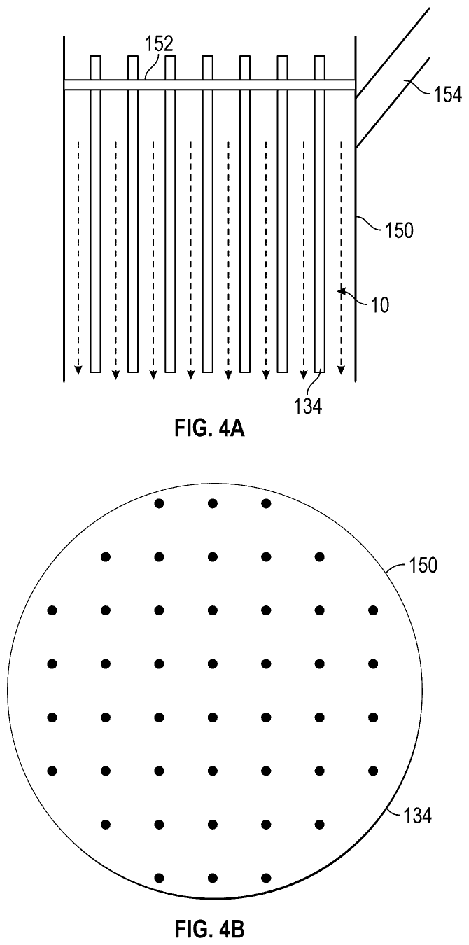

Referring to FIGS. 4A-B, there are shown various non-limiting arrays of energy emitting members 134 in accordance with the present disclosure.

FIG. 4A is a schematic elevation view of an enclosure 150. The energy emitting members 134 may be positioned in the enclosure 150, which may be a shell 132 (FIG. 1), a vessel 112 (FIG. 2), in a fluid line, e.g., line 16 (FIG. 3), or other suitable location. Optionally, the energy emitting members 134 may be suspended from a suitable structure such as a plate 152. An inlet 154 may be used, if needed, to feed the catalyst below the plate 152. The energy emitting members 134 may be energized using a suitable control system 136 and power source 137 (FIG. 1). It should be appreciated that energy is emitted outward from the members into the catalyst body 10 and also energy is applied along a defined axial length. Thus, energy is applied along an axial length of the catalyst body 10 and also radially along the catalyst body 10.

FIG. 4B is a schematic end view of an enclosure 150. In this embodiment, the energy emitting members 134 are positioned parallel to the flow of the catalyst (not shown). That is, the energy emitting members 134 extend lengthwise in a generally co-linear relationship with the flow of the catalyst (not shown) in the enclosure 150.

Thus, it should be noted that the energy emitting members 134 are not limited to any particular geometric configuration, shape or arrangement. Moreover, arrays of energy emitting members 134 may be distributed throughout the regenerator 100 (FIGS. 1 and 3) or other locations downstream of the regenerator 100 (FIGS. 1 and 3).

The words “comprising” and “comprises” as used throughout the claims, are to be interpreted to mean “including but not limited to” and “includes but not limited to”, respectively.

To the extent used herein, the word “substantially” shall mean “being largely but not wholly that which is specified.”

As used herein, the singular forms “a,” “an,” and “the” are intended to include the plural forms as well, unless the context clearly indicates otherwise.

To the extent used herein, the term “about” in reference to a given parameter is inclusive of the stated value and has the meaning dictated by the context (e.g., it includes the degree of error associated with measurement of the given parameter).

To the extent used herein, the term “and/or” includes any and all combinations of one or more of the associated listed items.

The foregoing description is directed to particular embodiments of the present disclosure for the purpose of illustration and explanation. It will be apparent, however, to one skilled in the art that many modifications and changes to the embodiment set forth above are possible without departing from the scope of the disclosure. It is intended that the following claims be interpreted to embrace all such modifications and changes.

What is claimed is:

1. A system for regenerating a spent catalyst into a reactivated catalyst having a predetermined heat content, the system comprising:
a reactor configured to generate the spent catalyst;
a regenerator configured to regenerate the spent catalyst from the reactor; and
an electrically energized heater configured to selectively increase a heat content of the spent catalyst to the predetermined heat content, the heater having a plurality of energy emitting members at least partially immersed in the spent catalyst.

2. The system of claim 1, wherein the heater is positioned external to the regenerator.

3. The system of claim 1, wherein the heater is positioned internal to the regenerator.

4. The system of claim 1, wherein the heater includes:
one or more shells positioned external to the regenerator, wherein the plurality of energy emitting members are positioned inside the shell,
a first inlet conveying the catalyst from the regenerator into the shell, and
a second inlet conveying a fluidizing agent into the shell.

5. The system of claim 4, wherein the heater further includes: a catalyst outlet from which the catalyst in the shell exits.

6. The system of claim 5, further comprising a gas outlet from which the fluidizing agent in the shell exits, and

7. The system of claim 1, further comprising a passage connecting the heater and the regenerator, wherein at least the catalyst enters and exits the regenerator via the passage.

8. The system of claim 1, further comprising an electrical power source configured to supply power to the heater.

9. The system of claim 8, wherein the electrical power source is a renewable power source.

10. The system of claim 1, wherein the heater is further configured to have a first selectable operating mode wherein the heat does not increase the heat content if one or more non-electrical sources increase the heat content to the predetermined heat content.

11. The system of claim 1, wherein the heater is further configured to have a second selectable operating mode wherein the heater and one or more non-electrical sources increase the heat content to the predetermined heat content.

12. The system of claim 1, wherein the heater is further configured to have a third selectable operating mode wherein only the heater increases the heat content to the predetermined heat content.

13. The system of claim 1, wherein the heater and one or more non-electrical sources increase the heat content to the predetermined heat content

14. A method for regenerating a spent catalyst into a reactivated catalyst having a predetermined heat content, the method comprising:
generating a spent catalyst in a reactor;
receiving the spent catalyst in a regenerator;
at least partially immersing a plurality of energy emitting members of a heater in the spent catalyst; and
selectively increasing a heat content of the spent catalyst to the predetermined heat content by using the heater.

15. The method of claim 14, wherein the heater includes at least one shell positioned external to the regenerator, wherein the plurality of energy emitting members are positioned inside the shell, and further comprising:
conveying the catalyst from the regenerator into the shell using a first inlet, and
conveying a fluidizing agent into the shell using a second inlet.

16. The method of claim 14, further comprising connecting the reactor and the regenerator with a passage, wherein at least the catalyst enters and exits the regenerator via the passage.

17. The method of claim 14, wherein selectively increasing includes not increasing the heat content if one or more non-electrical sources increase the heat content to the predetermined heat content.

18. The method of claim 14, wherein selectively increasing includes using the heater and one or more non-electrical sources to increase the heat content to the predetermined heat content.

19. The method of claim 14, wherein selectively increasing includes using only the heater to increase the heat content to the predetermined heat content.
